(19) United States
(12) Patent Application Publication
(10) Pub. No.: US 2025/0217584 A1
(43) Pub. Date: Jul. 3, 2025

(54) DISTRIBUTED LEDGER ENABLED LARGE LANGUAGE MODEL SECURITY PROTOCOL

(71) Applicant: American Express Travel Related Services Company, Inc., New York, NY (US)

(72) Inventors: Hiranmayi Palanki, Tampa, FL (US); Shankar Djeyassilane, Markham (CA)

(21) Appl. No.: 18/400,570

(22) Filed: Dec. 29, 2023

(51) Int. Cl. G06F 40/20

(52) U.S. Cl. CPC G06F 40/20

(57) ABSTRACT

Disclosed are various embodiments for a distributed ledger enabled large language model security protocol. A large language model (LLM) can filter data generated by a distributed agent for a trace of a transaction with a third-party LLM. A trained LLM can analyze any found trace of a transaction and identify at least an anomaly related to the found trace. The trained LLM can block the transaction based on the anomaly.

### BACKGROUND

Large language models (LLMs) are expanding the use of artificial intelligence (AI) exponentially. LLMs can be designed to understand and generate human-like content in the form of text, code, images, or audio. The content is created subsequent to an input, which could be from a human or another AI (e.g., another LLM, etc.). However, this content may include hallucinations, copyrighted material, inaccurate material, offensive material, or otherwise be undesirable to share or use.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is an example of a network environment according to various embodiments of the present disclosure.

FIGS. 2A and 2B are a sequence diagram representing operations performed in the network environment according to various embodiments of the present disclosure.

FIGS. 3A and 3B are a sequence diagram representing operations performed in the network environment according to various embodiments of the present disclosure.

FIG. 4 is a flowchart illustrating one example of functionality implemented as portions of an application executed in a computing environment in the network environment of FIG. 1 according to various embodiments of the present disclosure.

FIGS. 5A-5D are pictorial diagrams of examples of user interfaces rendered by a client according to various embodiments of the present disclosure.

### DETAILED DESCRIPTION

Disclosed are various approaches for a distributed ledger enabled large language model (LLM) security protocol. As technology advances and artificial intelligence (AI) becomes more widespread, LLMs are becoming ubiquitous. Use of LLMs has facilitated many functions, making complex tasks easier and quicker to perform. For instance, LLMs have been used to generate, summarize, and translate content. In addition, LLMs have been used to answer questions of many sorts, such as trivial questions, questions based on general knowledge, and questions requiring licensure in fields like technology, medicine, history, etc. As the use of LLMs has become more widespread, so has the misuse of LLMs.

Misuse of an LLM can involve either the prompt to the LLM, the response from the LLM, or both. For example, a response or a prompt could include content that is inaccurate, nonsensical, fictitious, inappropriate, breaches confidentiality, is offensive, is based on or communicates bias, violates a license, violates intellectual property protection (e.g., copyright), etc. Accordingly, a technical problem may arise when a LLM generates content that goes against set policy standards. By tracking and evaluating content that is created by an LLM, misuse of the LLM can be blocked from public exposure or disclosure.

As disclosed herein, a solution to this issue is to use a trained large language model to oversee transactions with other large language models. For example, the trained LLM could determine whether any misuse of another LLM is occurring. Moreover, the trained LLM could evaluate whether the misuse was intentional. The trained LLM could also cause the transaction with the other LLM to be blocked and/or notify relevant parties of the misuse of the other LLM. The trained LLM could also be periodically retrained based at least in part on the detected misuse in order to keep the trained large language model up to date.

While this disclosure relates to a third-party large language model and a trained large language model, the concepts presented are not to be considered as limited. For example, data being exchanged between a client application and a third-party large language model could be filtered, evaluated, and blocked, if necessary, by a computer program that is not a trained large language model. In addition, a trained large language model could be used to block material that is not presented by a third-party large language model. Furthermore, it could be two different sorts of computer programs that go through the steps mentioned below to accomplish a similar goal. A large language model could be trained in a supervised manner and/or a self-supervised manner. For example, a large language model could be trained by another task-specific large language model. Additionally, while this disclosure discusses transactions occurring on a distributed ledger and data being exchanged in relation to those transactions, it is possible to have the steps listed below occur via another medium or channel used to exchange data.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

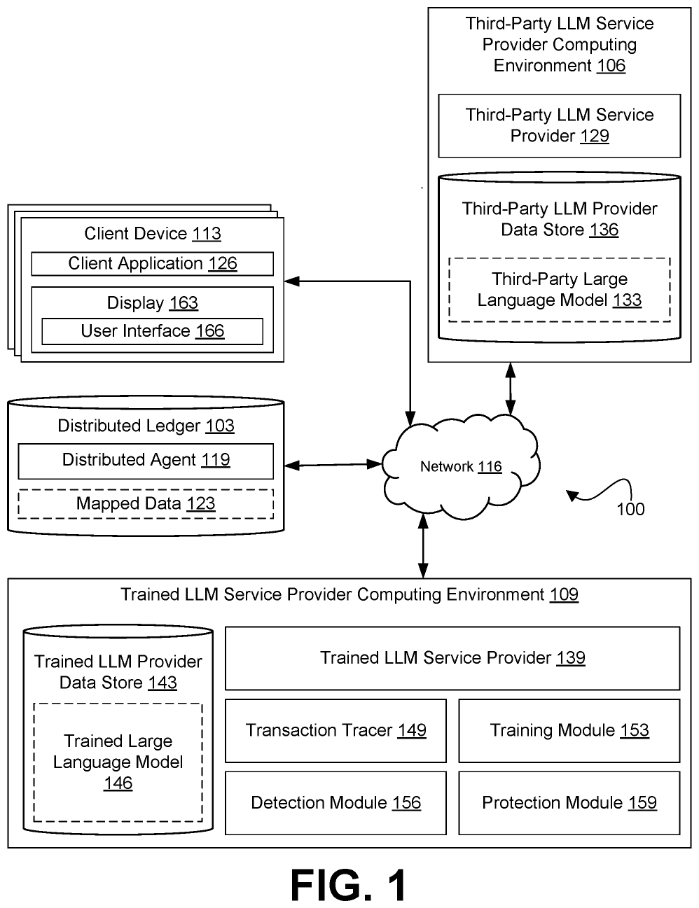

With reference to FIG. 1, shown is a network environment 100 according to various embodiments. The network environment 100 can include a distributed ledger 103, a third-party large language model (LLM) service provider computing environment 106, a trained large language model (LLM) service provider computing environment 109, and one or more client devices 113. Each of these can be in data communication with each other via a network 116.

The network 116 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 116 can also include a combination of two or more networks 116. Examples of networks 116 can include the Internet, intranets, extranets, virtual private networks (VPNs), and similar networks.

The distributed ledger 103 represents a synchronized, eventually consistent, data store spread across multiple nodes in different geographic or network locations. Each member of the distributed ledger 103 can contain a replicated copy of the distributed ledger 103, including all data stored in the distributed ledger 103. Each of the multiple nodes can be either private or public. A private node can be accessible only to peers with verified security credentials. A public node can be accessible to the general public. Records of transactions involving the distributed ledger 103 can be shared or replicated using a peer-to-peer network connecting the individual members that form the distributed ledger 103. Once a transaction or record is recorded in the distributed ledger 103, it can be replicated across the peer-to-peer network until the record is eventually recorded with all members. Various consensus methods can be used to ensure that data is written reliably to the distributed ledger 103. Examples of a distributed ledger can include blockchains, distributed hash tables (DHTs), and similar data structures. The distributed ledger 103 can include a distributed agent 119, mapped data 123, and various other components.

The distributed agent 119 can represent a script or other executable which can be stored in the distributed ledger 103 and executed by individual hosts or peers of the distributed ledger 103. When a computation is performed by the distributed agent 119, each host or peer that forms the distributed ledger 103 can perform the computation and compare its result with the results computed by other hosts or peers. When a sufficient number of hosts or peers forming the distributed ledger 103 agree on the result of the computation, the result can be stored in the distributed ledger 103. An example of a distributed agent 119 is a “smart contract” used in the ETHEREUM platform, although other distributed ledger or blockchain-based technologies provide the same or similar functionality which may also be referred to as a “smart contract.” In various examples, the distributed agent 119 can be present on at least one node of a distributed ledger 103 that is private, public, or a hybrid. For example, the distributed agent 119 can have private functions and/or public functions for performing one or more tasks based on a type of node it is on in the distributed ledger.

In various examples, the distributed agent 119 of the present disclosure can be invoked by a client application 126 of a client device 113 to request a response to a prompt. In some examples, the client application 126 can invoke the distributed agent 119 via an application programming interface (API) call and include the received prompt in the API call with the invocation request. In various examples, upon being invoked, the distributed agent 119 can generate a prompt identifier to identify the given prompt and update the mapped data 123 to include a private or public mapping of the prompt identifier and given prompt.

The distributed agent 119 can also generate and initiate a prompt event which can notify a plurality of service providers of a received prompt and request that the service providers generate responses to the received prompt. The distributed agent 119 can receive indications from the service providers that the provider responses have been transmitted to the distributed agent 119, the client device 113, etc.

Additionally, various data can be stored in the distributed ledger 103. This can include mapped data 123 and/or other information. However, any other data discussed in the present disclosure could also be stored in the distributed ledger 103 if the public availability of the data were acceptable in that particular implementation. A mapping of data occurs when a unique address in the distributed ledger 103 is associated to a specific value. Mapped data 123 can be in the form of relational databases or non-relational databases such as object-oriented databases, hierarchical databases, hash tables or similar key-value datastores, as well as other data storage applications or data structures. The distributed agent 119 can generate a prompt identifier and update the mapped data 123 accordingly. In various examples, mapped data 123 is a private mapping, while in other examples, the mapped data 123 is public. The mapped data 123 can be used to track a received prompt and a status of the received prompt. Examples of data mappers include Solidity, Vyper, JavaScript, Yul, etc.

The distributed agent 119 of the present disclosure can be invoked by a client application 126 of the client device 113 to request a response to a received prompt. In various examples, upon being invoked, the distributed agent 119 can generate a prompt identifier to identify the received prompt and update the mapped data 123 to include a private or public mapping of the prompt identifier and received prompt. The mapped data can be shared with LLM service providers.

The third-party LLM service provider computing environment 106 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the third-party LLM service provider computing environment 106 can employ a plurality of computing devices that can be arranged in one or more server banks or computer banks or other arrangements. Such computing devices can be located in a single installation or can be distributed among many different geographical locations. For example, the third-party LLM service provider computing environment 106 can include a plurality of computing devices that together can include a hosted computing resource, a grid computing resource or any other distributed computing arrangement. In some cases, the third-party LLM service provider computing environment 106 can correspond to an elastic computing resource where the allotted capacity of processing, network, storage, or other computing-related resources can vary over time.

Various applications or other functionality can be executed in the third-party LLM service provider computing environment 106. The components executed on the third-party LLM service provider computing environment 106 can include a third-party LLM service provider 129, and other applications, services, processes, systems, engines, or functionality not discussed in detail herein.

In various examples, the third-party LLM service provider 129 can be executed to interact with a distributed agent 119 stored in a distributed ledger 103 and executed by one or more computing nodes of the distributed ledger 103. In various examples, the third-party LLM service provider 129 can determine that a prompt event has been initiated by the distributed agent 119. In some examples, the third-party LLM service provider 129 receives a notification from the distributed agent 119 indicating the start of the prompt event. The notification can include a prompt that is generated by a client device 113, a prompt identifier, and/or other data.

In response to the prompt event, the third-party LLM service provider 129 can execute one or more third-party LLMs 133 to generate a provider response to a given prompt. A third-party LLM 133 can represent any language model that includes a neural network with many parameters (tens of thousands, millions, or sometimes even billions or more) that is trained on large quantities of unlabeled text using self-supervised learning or semi-supervised learning techniques. At least some third-party LLMs 133 can be generative—that is they can generate new data based at least in part on patterns and structure learned from their input training data. Examples of large language models include various versions of OPENAI's Generative Pre-trained Transformer (GPT) model (e.g., GPT-1, GPT-2, GPT-3, GPT-4, etc.), META's Large Language Model Meta AI (LLaMA), and GOOGLE's Pathways Language Model 2 (PaLM 2), among others.

LLMs, and machine learning models in general, often represent a vector, matrix, or other data structure containing multiple parameters and weights. Accordingly, while LLMs are data models, they can be applied to one or more inputs, often referred to as a “prompt,” which list a desired output and one or more constraints. Accordingly, LLMs, including the third-party LLM 133, are often described as being configured to perform some sort of action or return some sort of response to a prompt.

A third-party LLM 133 can be configured to return a response to a prompt, which can be in a structured form (e.g., a request or prompt with a predefined schema and/or parameters) or in an unstructured form (e.g., free form or unstructured text). In some examples, the third-party LLM service provider 129 can notify the distributed agent 119 of the location address of the LLM service provider response.

Also, various data is stored in a third-party LLM provider data store 136 that is accessible to components associated with the third-party LLM service provider computing environment 106 (e.g., the third-party LLM service provider 129). The third-party LLM provider data store 136 can be representative of a plurality of third-party LLM provider data stores 136, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the third-party LLM provider data store 136 is associated with the operation of the various applications or functional entities described below. This data can include data associated with a third-party LLM 133, and potentially other data.

The trained LLM service provider computing environment 109 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the trained LLM service provider computing environment 109 can employ a plurality of computing devices that can be arranged in one or more server banks or computer banks or other arrangements. Such computing devices can be located in a single installation or can be distributed among many different geographical locations. For example, the trained LLM service provider computing environment 109 can include a plurality of computing devices that together can include a hosted computing resource, a grid computing resource or any other distributed computing arrangement. In some cases, the trained LLM service provider computing environment 109 can correspond to an elastic computing resource where the allotted capacity of processing, network, storage, or other computing-related resources can vary over time.

Various applications or other functionality can be executed in the trained LLM service provider computing environment 109. The components executed on the trained LLM service provider computing environment 109 can include a trained LLM service provider 139, a trained LLM provider data store 143, and other applications, services, processes, systems, engines, or functionality not discussed in detail herein.

The trained LLM service provider 139 can be executed in response to the interaction between the distributed agent 119 and the third-party LLM service provider computing environment 106. In various examples, the interaction between the distributed agent 119 and the third-party LLM service provider computing environment 106 can include an exchange of data between the distributed agent 119 and the third-party LLM service provider computing environment 106. The exchange of data can include, for example, a transmission, a notification, or another form of communication, sent from the distributed agent 119 to the third-party LLM service provider computing environment 106, or vice versa. In response to the interaction, the trained LLM service provider 139 can execute one or more trained large language models 146 associated with the trained LLM provider data store 143 to pause, block, or otherwise impede anomalous interactions. A trained LLM 146 can represent any language model that includes a neural network with many parameters (tens of thousands, millions, or sometimes even billions or more) that is trained on large quantities of unlabeled text using self-supervised learning or semi-supervised learning techniques.

In some implementations, a large language model trained with unsupervised learning can use bootstrapping to train the trained LLM 146. As new patterns and anomalies are detected and blocked, new block states can be provided to train the trained LLM 146. The new block states can also be used to retrain the trained LLM 146 for further advancement in its ability to safeguard against misuse. Alternatively, or in addition, the trained LLM 146 can be provided labelled data or other learning materials from an operator or another entity and be trained via supervised learning. Some trained LLMs 146 may be generative—that is they can generate new data based at least in part on patterns, anomalies, and structures learned from their training data. Furthermore, in some examples, the trained LLM service provider 139 can record details, including transaction metadata, associated with the blocked transaction on the distributed ledger 103. These recorded details associated with the blocked transaction can serve as new block states, as mentioned above, to further advance an initial training or cause a retraining of the trained LLM 146. Additionally, the trained LLM service provider 139 can report details, including the transaction metadata, of the blocked transaction to the distributed agent 119, the client device 113, etc.

Also, various data is stored in a trained LLM provider data store 143 that is accessible to the trained LLM service provider computing environment 109. The trained LLM provider data store 143 can be representative of a plurality of trained LLM provider data stores 143, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the trained LLM provider data store 143 is associated with the operation of the various applications or functional entities described below. As mentioned above, this data can include one or more trained LLMs 146, and potentially other data.

The trained LLM 146 can generate a score regarding the similarity between at least an anomaly found in a new transaction and at least an anomaly from preexisting data (e.g., a historical transaction, a generated transaction, etc.). An anomaly found in preexisting data can be defined as a preexisting anomaly. In some examples, when the score generated by the trained LLM 146 is of at least a predetermined value or within a range of predetermined values, the similarity between the anomaly found in the new transaction and the anomaly from preexisting data can be determined to be at a predetermined level of closeness. In some examples, a cosine similarity may be what is used to determine whether at least an anomaly from a new transaction meets a threshold of similarity to at least an anomaly from preexisting data. The anomalies from preexisting data are recorded on the distributed ledger 103 and stored in the trained LLM provider data store 143. The anomalies recorded on the distributed ledger can be made public or kept private. The trained LLM 146 can interact with and employ at least a transaction tracer 149, a training module 153, a detection module 156, a protection module 159, or other modules.

When a new transaction is found to have at least one similarity with at least one historical or generated transaction, it is analyzed to determine a number of anomalies and a ranking of anomalies. If the number of anomalies determined is higher than a predefined amount based, the new transaction is flagged. Additionally, in some examples, if a ranking of a type of anomaly meets certain requirements, the new transaction is flagged as well. If a new transaction is found to be similar to a preexisting data (e.g., historical transactions, generated transactions, etc.), the amount of similarity will be determined and evaluated to conclude on a number of anomalies present and to assign an abnormality score. In some examples, a ranking and/or threshold-based method can used to raise alarms for transactions with a predefined number or type of abnormality scores. Overall, a new transaction is determined to be an issue if it contains at least an anomaly that is similar at least an anomaly from a historical transaction or a generated transaction.

To detect the new transaction, the trained LLM 146 can use a transaction tracer 149 to examine the distributed ledger 103 and capture data exchanged on it. Based on the captured data, the transaction tracer 149 can extract and record at least a trace of a transaction, the trace comprising such details like transaction identifiers, timestamps, and other relevant metadata upon the initiation of a transaction. As the transaction is propagated through the distributed ledger 103, the transaction tracer 149 can record the nodes that receive and relay the transaction. Accordingly, a transaction trace can represent a snapshot of a transaction. The snapshot can include an identifier of the distributed agent 119 being invoked for the transaction and the related inputs and outputs associated with the distributed ledger 103. Upon the transaction reaching a verification node (a node responsible for verifying the transaction), the transaction tracer 149 can record the acceptance or rejection of the transaction. When the transaction is verified by a threshold number of verification nodes, the transaction tracer 149 can record the block in which the transaction is confirmed. When the transaction is included in a block, the transaction tracer 149 can record the execution of the transaction's distributed agent 119 or other effects.

In various examples, the transaction tracer 149 can be used by the trained LLM 146 to capture an execution of a transaction between the distributed agent 119, accessed by the client device 113, and the third-party LLM service provider computing environment 106. The transaction tracer 149 can filter the distributed ledger 103 and capture an exchange of data between the distributed agent 119 and the third-party LLM 133. The captured data can include inputs and outputs associated with the distributed agent 119 and the third-party LLM 133. The captured data can include details related to the time taken for the third-party LLM 133 to process each input and generate each output. The captured data can include resources from the third-party service provider computing environment 106 used by the third-party LLM 133. The captured data can include performance of the third-party LLM 133 over time. Furthermore, the trained LLM 146 is trained on data captured from an application of the transaction tracer 149 at least in part on preexisting data. As a result, the trained LLM 146 can differentiate between normal transactions and anomalous transactions between the client device 113, the distributed agent 119, and the third-party LLM 133.

A training module 153 can process training data and extract relevant information to improve the trained LLM's 146 abilities to distinguish normal transactions from abnormal ones. In addition, the training module 153 can process training data and extract relevant information to improve the trained LLM's 146 abilities to detect anomalies. The training module 153 can improve the trained LLM's 146 abilities by preprocessing preexisting data stored in the trained LLM provider data store 143. The preexisting data can include data associated with historical transactions. The preexisting data can include data associated with generated transactions. The generated transactions can be based on self-supervised learning performed by the trained LLM 146. The preexisting data, whether from the historical transactions, the generated transactions, or elsewhere, can include anomalies of different types, rankings, and structures. The training module 153 can extract relevant features from the preexisting data and use them to optimize the trained LLM's 146 parameters. The extracted features can include sentence representations, object recognition, sentiment analysis in lyrics, details associated with key and tempo, sound structures, color features, contextual information, etc. The training module 153 can test the performance of the trained LLM's 146 improved abilities using stored datasets and identify areas that need improvement. In various examples, the training module 153 uses a dataset of historical transactions to train the trained LLM 146 using self-supervised or supervised methods. The goal of this training phase is to learn to differentiate between normal and abnormal transactions and analyze details, including transaction metadata, within each. As a result, the trained LLM 146 is made capable of identifying anomalies in real-time third-party LLM 133 interactions with the distributed agent 119.

A detection module 156 can be designed to identify or detect specific patterns or anomalies in inputs and/or outputs. For example, the detection module 156 can detect an anomaly in a transaction between the distributed agent 119 and the third-party LLM 133 that is published on the distributed ledger 103. The detection module 156 can identify harmful or inappropriate content (hereby referred to together as “misuse”). Content can be determined to be harmful if it involves such things as hate speech, offensive language, language that expresses bias towards or against any person or entity for any reason, etc. Content can be determined to be inappropriate if it violates set policy standards, laws, regulations, etc. For example, identified inappropriate content can be inaccurate, nonsensical, fictitious, protected health information, a government identification number (e.g., a social security number), etc. Inappropriate content can also be data that violates a person or entity's copyright protection or licensing rights. Accordingly, an anomalous transaction can be determined if the inputs and/or the outputs include information or data that is inaccurate, nonsensical, fictitious, inappropriate, breaches confidentiality, is offensive, is based on or communicates bias, violates a license, violates intellectual property protection (e.g., copyright), etc. Additionally, or alternatively, an anomalous transaction can be determined if the inputs and/or the outputs violate applicable standards. In contrast, a normal transaction can be determined if the inputs and/or outputs are devoid of any anomalies or a predefined number of anomalies. Additionally, or alternatively, a normal transaction can be determined based on the inputs and/or outputs following applicable standards.

In various examples, the trained LLM 146 can use the detection module 156 to analyze at least transaction traces of a transaction to determine if any specific patterns or anomalies that comprise a misuse exist within the data associated with the transaction. In some examples, a new transaction can be transformed by the trained LLM 146 or other means into a normalized vector representation by using at least a vocabulary embedding layer. Anomalies found in the normalized vector representations of the new transaction can be compared to anomalies found in normalized vector representations of historical or generated transactions to determine a level of similarity between the two.

A protection module 159 can be designed to safeguard the LLMs 133 and 146 from various threats, including misuse. The protection module 159 can play a role in ensuring the security and integrity of LLMs 133 and 146 and protecting them from vulnerabilities that could compromise their functioning and cause misuse. The trained LLM 146 can use the protection module 159 to validate and filter input data, to detect and mitigate adversarial attacks aimed at exploiting vulnerabilities in the platform or any associated components (e.g., client device 113, network 116, etc.), to implement privacy-preserving steps to protect sensitive data from exposure, and to detect and mitigate biases present in any transaction that takes place between the distributed agent 119 and the third-party LLM 133. On top of all of this, the protection module 159 can also monitor in real-time any inputs and outputs associated with the distributed agent 119 and the third-party LLM 133, and the internal states of the distributed agent 119, the third-party LLM service provider computing environment 106, and the trained LLM service provider computing environment 109. Furthermore, when an anomaly is discovered, the protection module 159 can generate and transmit alerting notifications to any relevant personnel or system. The protection module 159 monitoring real-time can lead to immediate detection of any misuse and the notifications can cause a timely investigation into potential issues.

The protection module 159 can be used by the trained LLM 146 to prevent misuse to be communicated to or expressed on the platform, whether the platform be the client device or another computing device, based on the number and type of anomalies determined by the detection module 156. The misuse can be prevented by at least causing the distributed agent 119 to be paused. Alternatively, the misuse can also be prevented by isolating the data associated with the transaction associated with the distributed agent 119 and the third-party LLM service provider computing environment 106. The trained LLM 146 can use the protection module 159 to determine a type of misuse by running multiple tests. The tests may include a harmful content test, a bias test, a sensitive data element (SDE) test, a hallucination test, a code generator test, an offensive language test, a copyright test, a license violation test, or a combination thereof.

A harmful content test can include manual and automated identification of offensive, inappropriate, or dangerous material. Harmful content can include explicit content, hate speech, cyberbullying, misinformation, scams, and so on. Harmful content tests can include testing the response from the distributed agent 119, the LLMs 133 and 146, or the LLM service providers 129 and 139 for harmful content. Harmful content tests can provide predetermined or manual inputs designed to provoke harmful content responses, and check responses from an LLM for harmful content.

A bias test can include manual and automated identification of biases in an LLM, including its communications in response to certain inputs. The bias test can test for preconceived notions, prejudices, or unfair judgments that can have negative consequences for individuals or groups. The tested biases can include racial biases, sexual biases, gender biases, age biases, disability biases, religious biases, socioeconomic biases, beauty biases, and other biases. Bias mitigation tests can include testing the response from the distributed agent 119, the LLMs 133 and 146, or the LLM service providers 129 and 139 for biases. Bias tests can provide predetermined or manual inputs designed to provoke biased LLM outputs, and check responses from an LLM for biases.

SDE tests can include manual and automated identification of SDEs in an LLM, including its communications in response to certain inputs. The SDE test can identify SDEs such as personal names, dates of birth, social security numbers, addresses, phone numbers, email addresses, financial information, health information, driver's license numbers, passport numbers, national identification numbers, biometric data, authentication information, employment information, criminal history, ethnicities, races, sexual orientations, gender identities, religious affiliations, political affiliations, child information, and so on. SDE tests can ensure that an LLM does not provide SDEs in response to testing inputs. SDE leakage tests can include testing the response from the distributed agent 119, the LLMs 133 and 146, or the LLM service providers 129 and 139 for SDEs. SDE can provide predetermined or manual inputs designed to provoke SDEs, and check responses from an LLM for SDEs.

Hallucination tests can include manual and automated identification of hallucinations in an LLM, including its communications in response to certain inputs. LLMs can sometimes generate responses that seem plausible but are actually inaccurate, fictional, or unsupported by facts. These inaccurate LLM responses can be referred to as “hallucinations.” A hallucination test can check whether the outputs generated by the LLM are factually accurate according to a predetermined and stored factual knowledge base. Hallucination tests can ensure that an LLM does not provide inaccurate information in response to testing inputs. Hallucination tests can provide predetermined or manual inputs designed to provoke hallucinations, and check responses from an LLM for accuracy.

Code generation can include reliance on an LLM to generate code based on input provided. A code generator test can check whether the data being shared can be used to generate new code, whether the new code can cause negative effects upon execution, and the magnitude of the negative effects. Code generation tests can provide predetermined or manual inputs designed to provoke code generations, and check responses from an LLM for effects based on execution of the generated code.

Offensive language tests can include manual and automated identification of offensive language in an LLM, including its communication in response to certain inputs. An offensive language test can check whether the data being shared, whether as input to the LLM or a response from the LLM, contains images, sounds, or language presented in any form that may be offensive to any person, entity, or organization. Offensive language tests can ensure that an LLM does not provide information in a way that may be considered offensive to any person, entity, or organization. Offensive language tests can provide predetermined or manual inputs designed to provoke responses, and to check to see whether the responses provided are offensive.

A copyright test can include determining whether material being shared as a response is shareable and is not infringing on intellectual property protection as related to copyright law. A copyright test can check whether the LLM will present information as original content that has already been claimed by another person, entity, or organization. Copyright tests can ensure that an LLM does not provide information in a way that communicates it created something when the LLM is instead repeating material that is the intellectual property of a person, entity, or organization. Copyright tests can provide predetermined or manual inputs designed to provoke responses, and to check to see whether the responses provided are a violation of protection and ownership granted by copyright law.

A license violation test can include checking whether there is any use, distribution, or modification of a software product or its source code in a manner that is not in compliance with the terms and conditions specified by the software's license. A license violation test can check whether the LLM is using software owned by another person, entity, or organization, in ways that go beyond any rights to do so. License violation tests can ensure that an LLM does not use or cause use of software that requires a license to use without first getting the permissions. License violation tests can provide predetermined or manual inputs designed to provoke responses that may include licensed software, and to check to see whether the responses provided are a violation of or encourage a violation of the licensed software.

The client device 113 is representative of a plurality of client devices 113 that can be coupled to the network 116. The client device 113 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 113 can include one or more displays 163, such as liquid crystal displays (LCDs), gas plasma-based flat panel displays, organic light emitting diode (OLED) displays, electrophoretic ink (“E-ink”) displays, projectors, or other types of display devices. In some instances, the display 163 can be a component of the client device 113 or can be connected to the client device 113 through a wired or wireless connection.

The client device 113 can be configured to execute various applications such as a client application 126 or other applications. The client application 126 can be executed in a client device 113 to access network content served up by the third-party LLM service provider computing environment 106, the trained LLM service provider computing environment 109, the distributed agent 119 associated with the distributed ledger 103, or other servers, thereby rendering a user interface 166 on the display 163. To this end, the client application 126 can include a browser, a dedicated application, or other executable, and the user interface 166 can include a network page, an application screen, or other user mechanism for obtaining user input. The client device 113 can be configured to execute applications beyond the client application 126 such as email applications, social networking applications, word processors, spreadsheets, or other applications.

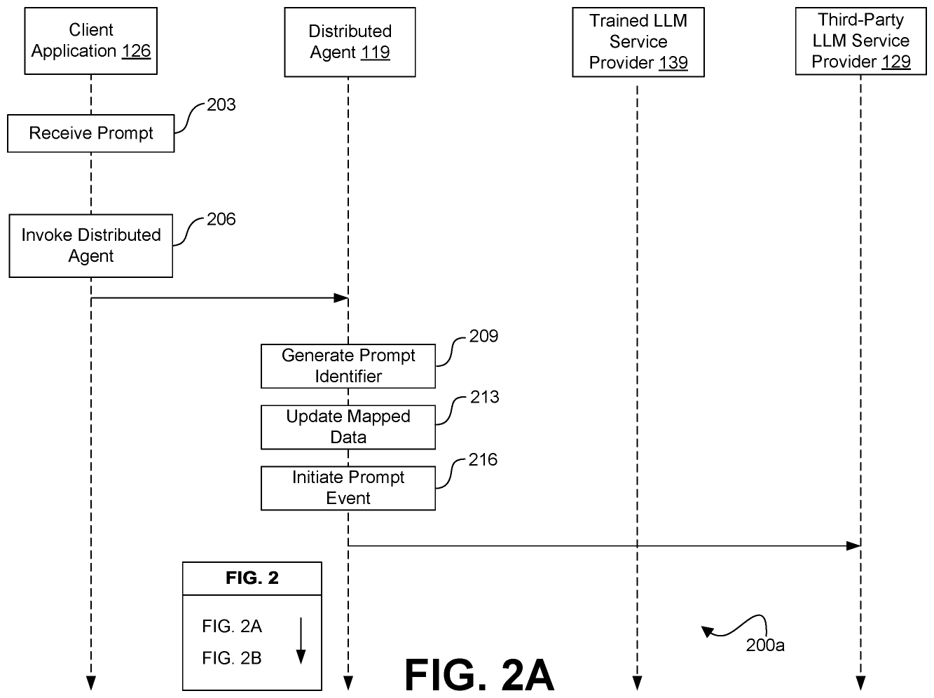

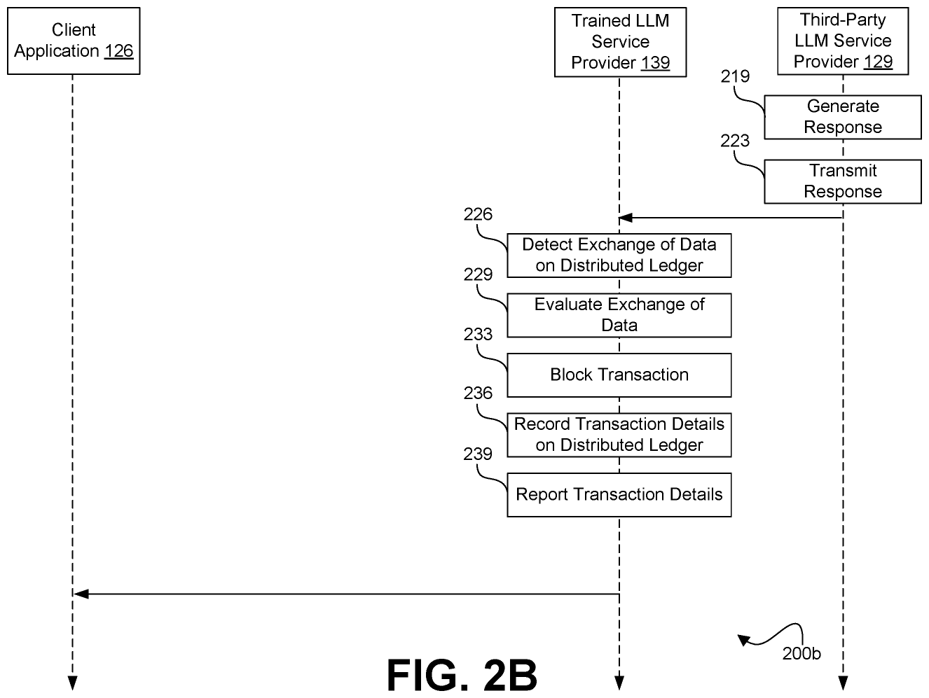

Next, a general description of the operation of the various components of the network environment 100 is provided. Although the following paragraphs describe one example of the interactions between the various components of the various embodiments of the present disclosure, other interactions or sequences of interactions are possible. Additional detail about particular sequences of interactions is further provided in the discussion accompanying FIGS. 2A, 2B, 3A, 3B, and 4.

To begin, a user can use a client device 113 to interact with a third-party LLM 133. For example, the user could utilize a mobile application, web portal, or other user interface that allows a user to submit a prompt to a third-party LLM 133 (e.g., ask a question). In response to the user's prompt being submitted, a distributed agent 119 hosted by a distributed ledger 103 can be invoked. The distributed agent 119 can generate an identifier for the prompt, make an update to the address of the prompt on the distributed ledger 103, and cause the third-party LLM service provider 129 to respond to the prompt (e.g., answer the question). The third-party LLM service provider 129 can use the third-party LLM 133 to generate and transmit a response on the distributed ledger 103.

At this point, a trained LLM service provider 139, which has been evaluating the distributed ledger 103, and is associated with the client device in one form or another, can take note of the response being transmitted by the third-party LLM service provider 129. The trained LLM service provider 139 can evaluate this exchange of data (e.g., the generated response being transmitted) being transmitted and block the transaction if the data fails a predefined or specified number of tests analyzing the shareability of the data being exchanged. Furthermore, the trained LLM service provider 139 can continue to record the transaction details, including content and metadata, on the distributed ledger 103 and can report the transaction details to the client device 113 and therefore the user.

Referring next to FIGS. 2A and 2B, illustrated is a sequence diagram 200 (e.g., 200a and 200b) that provides a non-exhaustive example of the operation of the components of the network environment 100. It is understood that the sequence diagram 200 of FIGS. 2A and 2B provides merely an example of the many different types of functional arrangements that can be employed to implement the operation of the depicted portion of the network environment 100. As an alternative, the sequence diagram 200 of FIGS. 2A and 2B can be viewed as depicting an example of elements of a method implemented within the network environment 100.

Beginning with block 203, a client application 126 can receive a prompt via an interaction with the client device 113. In some examples, a user can enter a prompt in text form via a user interface 166 rendered or otherwise displayed on the display 163 associated with the client device 113. In other examples, the user can provide a prompt through interactions with a voice user interface or an interactive vertical assistant. In some examples, the received prompt is generated by an application or service executing on the client device 113. For example, the received prompt can be digitally generated by another application and/or the client application 126 to obtain information or data required to perform some sort of function. The received prompt can correspond to a prompt or question that requires an answer or response.

At block 206, the client application 126 can invoke a distributed agent 119 that is executable on a distributed ledger 103. The client application 126 can invoke the distributed agent 119 by providing the distributed agent 119 with appropriate configuration data related to the received prompt. The configuration data can include a task identifier, a target identifier, input data, context information, quality expectations, etc. For example, the client application 126 can provide the distributed agent 119 with the prompt (input data) to initiate a prompt event (task identifier) with the third-party LLM (target identifier), and provide additional transaction metadata related to the context of the receipt of the prompt (e.g., time, place, source, etc.), and a level of verification on the distributed ledger 103 the response should have reached (quality expectations).

At block 209, the distributed agent 119 can generate a prompt identifier. In various examples, the distributed agent 119 can create and/or associate certain values or details with the prompt, thereby generating a prompt identifier. The prompt identifier comprises an identifier that uniquely identifies the received prompt. In various examples, the prompt identifier can comprise randomly generated numeric or alphanumeric characters.

At block 213, the distributed agent 119 updates the mapped data to include a mapping of the prompt identifier and the received prompt. The distributed agent 119 can update the mapping of the prompt identifier and the received prompt by storing details, including transaction metadata, associated with the positioning of the prompt identifier and the received prompt in the distributed ledger 103. In various examples, the mapping is a private mapping, while in other examples, the mapping is public. The mapped data can be used to track the received prompt and the status of the received prompt prior to returning an accurate response to the client application 126.

At block 216, the distributed agent 119 can initiate a prompt event from a service provider on the distributed ledger 103. A prompt event can be initiated with participating LLM service providers. In FIGS. 2A and 2B, the participating LLM service provider is the third-party LLM service provider 129 included in the third-party LLM service provider computing environment 106. The prompt event can be initiated by sending the third-party LLM service provider 129 a request to determine a response to the received prompt. The initiate prompt event request can be transmitted or otherwise broadcasted to any registered LLM service providers 129 and 139 and can include the received prompt and prompt identifier associated with the received prompt event. Accordingly, the distributed agent 119 can alternatively, or in addition, also initiate a prompt event with the trained LLM service provider 139 for various reasons. For example, the distributed agent 119 can initiate the prompt event with the trained LLM service provider 139 for an evaluation of the received prompt with a goal of detecting any misuse. Initiating a prompt event with one LLM service provider does not mean that initiating prompt events with other LLM service providers is no longer possible.

At block 219, the third-party LLM service provider 129 can generate a provider response to the received prompt. For example, the third-party LLM service provider 129 can execute one or more third-party LLMs 133 to generate a provider response to a given prompt. The third-party LLM service provider 129 can execute the third-party LLM 133 and apply the received prompt as a prompt to the third-party LLM 133. The output of the third-party LLM 133 can comprise a generated response to the received prompt.

At block 223, the third-party LLM service provider 129 can transmit or otherwise broadcast a location of the generated response to the distributed agent 119 and/or client application 126. In some examples, the third-party LLM service provider 129 can write or otherwise store the generated response on the distributed ledger 103. For example, the generated response can invoke a write function associated with the third-party LLM service provider 129 to write the generated response to the distributed ledger 103. In some examples, the third-party LLM service provider 129 can obtain the location address associated with the generated response that is published on the distributed ledger 103. In other examples, the third-party LLM service provider 129 defines the location address associated with the generated response on the distributed ledger 103. The location of the generated response can be transmitted or otherwise broadcast to the distributed agent 119 and/or client application 126. In some examples, the location address associated with the generated response is transmitted to the distributed agent 119 and/or the client application 126 through an API call. Alternatively, the third-party LLM service provider 129 can transmit the location address of the generated response to the distributed agent 119 and/or client application 126 through various means that include messaging protocols (e.g., MQTT, AMQP, etc.), web sockets, and file transfer protocols (e.g., FTP, STFP, etc.).

At block 226, the trained LLM service provider 139 can detect an exchange of data on the distributed ledger 103. In various examples, a transaction tracer 149 can be used by the trained LLM service provider 139 and/or the trained LLM 143 to detect the exchange of data via examination of the distributed ledger 103 and capturing data exchanged on it. Via the transaction tracer 149, the trained LLM service provider 139 can capture an execution of a transaction between the distributed agent 119 and the third-party LLM service provider computing environment 106.

At block 229, the trained LLM service provider 139 can evaluate the exchange of data captured by the transaction tracer 149. In some examples, the trained LLM service provider 139 can calculate a similarity (or difference) between data captured from the exchange of data and preexisting data. In some examples, the data captured from the exchange of data can be transformed into normalized vector representations by the trained LLM 146 or other means and compared to normalized vector representations of preexisting data. Furthermore, a calculation for similarity can be performed between the normalized vector representation of the data captured from the exchange of data and preexisting vector representations (e.g., normalized vector representations of preexisting data that are stored in the trained LLM provider data store 143). The calculation may be based on a cosine similarity. Alternatively, the similarity may be based on Euclidean distance or dot product similarity or a similarity of another sort. The vector representation may be put through at least a test to determine at least a similarity with preexisting vector representations. The tests may include a hallucination test, a bias test, a copyright test, a code generator test, a harmful content test, an offensive language test, a sensitive data element test, a license violation test, or a combination thereof. The vector representations transformed from the data being exchanged does not have to be identical to preexisting vector representations but instead can be of a predetermined or particular level of similarity.

At block 233, the trained LLM service provider 139 can block the transaction, including the exchange of data, from reaching the distributed agent 119 and/or the client application 126 upon a detection of at least an anomaly. In some examples, the trained LLM service provider 139 can use a protection module 159 to prevent the anomaly from exposure to the distributed ledger 103 (via, for example, causing invalidation, revoking access to nodes, etc.). In some examples, the trained LLM service provider 139 can use the protection module 159 to prevent the anomaly from exposure to the distributed agent 119 (via, for example, interception and blockage of any transmissions that contain the address of the generated response). In some examples, the trained LLM service provider 139 can use the protection module 159 to prevent the anomaly from exposure to the client application 126 (via, for example, interception and blockage of any transmissions that contain the address of the generated response).

At block 236, the trained LLM service provider 139 can record details, including transaction metadata, associated with the blocked transaction on the distributed ledger 103. In some examples, the trained LLM service provider 139 can write or otherwise store the detailed associated with the blocked transaction on the distributed ledger 103. For example, blocking of the transaction can invoke a write function associated with the third-party LLM service provider 129 to write the details associated with the blocked transaction, including details associated with at least an anomaly that was found, to the distributed ledger 103.

Furthermore, at block 239, the trained LLM service provider 139 can report details, including transaction metadata, associated with the blocked transaction to the client application 126 associated with the client device 113. In some examples, the trained LLM service provider 139 can transmit the details associated with the blocked transaction to the distributed agent 119 and/or client application 126 over the network 116, via an API call, and/or other means of communication. The client application 126 can render or otherwise display a notification or alert concerning the blocked transaction on a user interface 166 to allow a user to review the details associated with the blocked transaction. Thereafter, this portion of the process can proceed to completion.

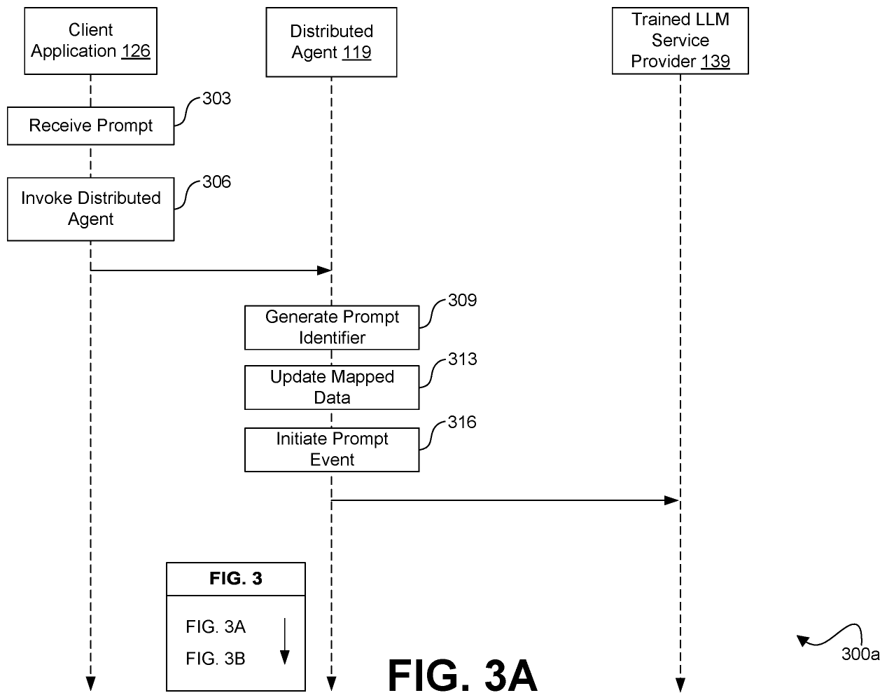

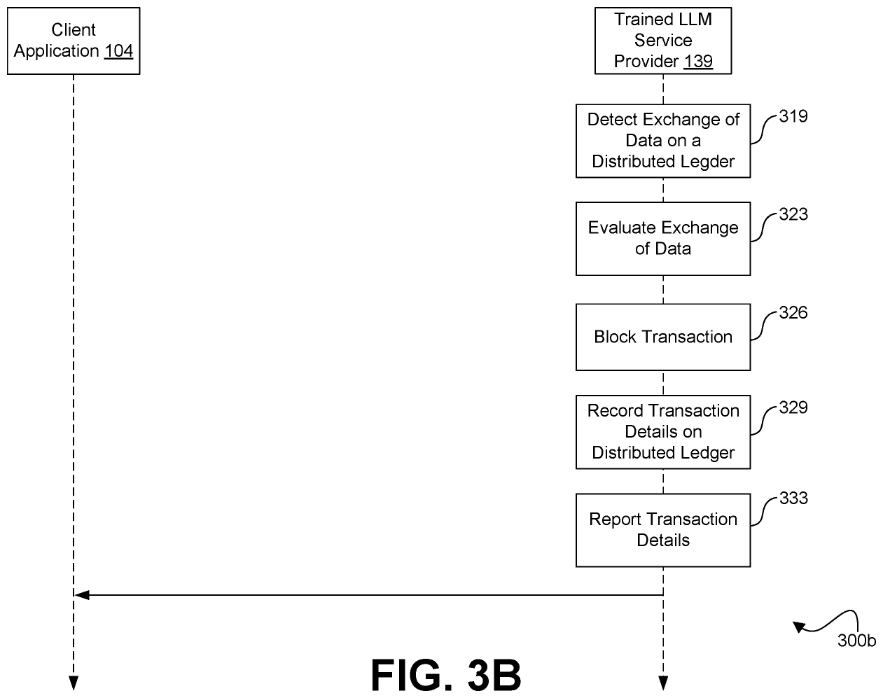

Proceeding next to FIGS. 3A and 3B, illustrated is a sequence diagram 300 (e.g., 300a and 300b) that provides another non-exhaustive example of the operation of the components of the network environment 100. It is understood that the sequence diagram 300 of FIGS. 3A and 3B provides merely another example of the many different types of functional arrangements that can be employed to implement the operation of the depicted portion of the network environment 100. As an alternative, the sequence diagram 300 of FIGS. 3A and 3B can be viewed as depicting another example of elements of a method implemented within the network environment 100.

FIGS. 2A and 2B can be seen as illustrating a sequence of operations in which the distributed agent 119 is able to initiate a prompt event with the third-party LLM service provider 129. In this scenario, the trained LLM service provider 139 is able to detect the exchange of data when a response is generated and transmitted by the third-party LLM service provider 129. Upon detection of the response, the trained LLM service provider 139 evaluates the exchange of data and proceeds to the block the transaction when appropriate.

In contrast, FIGS. 3A and 3B can be seen as illustrating a sequence of operations with the trained LLM service provider 139 detecting the exchange of data on the distributed ledger 103 when the distributed agent 119 initiates a prompt event. Upon the detection of the initiation, the trained LLM service provider 139 evaluates the exchange of data and blocks the transaction when appropriate. FIGS. 2A and 2B are similar to FIGS. 3A and 3B in the sense that the trained LLM service provider 139 is able to block the transaction, when appropriate, and differ only to show the different circumstances in which the trained LLM service provider 139 can block transactions.

Beginning with block 303, a client application 126 can receive a prompt via an interaction with the client application 126. In some examples, a user can enter a prompt in text form in a user interface 166 rendered or otherwise displayed on the display 163 associated with the client device 113. In other examples, the user can provide a prompt through interactions with a voice user interface or an interactive vertical assistant. In some examples, the received prompt is generated by an application or service executing on the client device 113. For example, the received prompt can be digitally generated by another application and/or the client application 126 to obtain information or data required to perform some sort of function. The received prompt can correspond to a prompt or question that requires an answer or response.

At block 306, the client application 126 can invoke a distributed agent 119 that is executable on a distributed ledger 103. The client application 126 can invoke the distributed agent 119 by providing the distributed agent 119 with appropriate configuration data related to the received prompt. The configuration data can include a task identifier, a target identifier, input data, context information, quality expectations, etc. For example, the client application 126 can provide the distributed agent 119 with the prompt (input data) to initiate a prompt event (task identifier) with the third-party LLM (target identifier), and provide additional details related to the context of the receipt of the prompt (e.g., time, place, source, etc.), and a level of verification on the distributed ledger 103 the response should have reached (quality expectations).

At block 309, the distributed agent 119 can generate a prompt identifier. In various examples, the distributed agent 119 can create and/or associate certain values or details with the prompt, thereby generating a prompt identifier. The prompt identifier comprises an identifier that uniquely identifies the received prompt. In various examples, the prompt identifier can comprise randomly generated numeric or alphanumeric characters. The prompt identifier can comprise an identifier that uniquely identifies the received prompt. In various examples, the prompt identifier can comprise randomly generated numeric or alphanumeric characters.

At block 313, the distributed agent 119 can update the mapped data to include a mapping of the prompt identifier and the received prompt. The distributed agent 119 can update the mapping of the prompt identifier and the received prompt by storing details, including transaction metadata, associated with the positioning of the prompt identifier and the received prompt in the distributed ledger 103. In various examples, the mapping is a private mapping, while in other examples, the mapping is public. The mapped data can be used to track the received prompt and the status of the received prompt prior to returning an accurate response to the client application 126. In various examples, the mapping is a private mapping, while in other examples, the mapping is public. The mapped data can be used to track the received prompt and the status of the received prompt.

At block 316, the distributed agent 119 can initiate a prompt event on the distributed ledger 103. The prompt event can be initiated with participating LLM service providers. In FIGS. 3A and 3B, the participating LLM service provider can be the trained LLM service provider 139 included in the trained LLM service provider computing environment 109. The prompt event can be initiated by sending the trained LLM service provider 139 a request to determine a response to the received prompt. The initiate prompt event request can be transmitted or otherwise broadcasted to any registered LLM service providers 129 and 139 and can include the received prompt and prompt identifier associated with the received prompt event. In some examples, the distributed agent 119 can exclusively initiate the prompt event with the third-party LLM service provider 129. In some other examples, despite the distributed agent 119 selecting to initiate the prompt event with the third party LLM service provider 129, the trained LLM service provider 139 can intercept the relevant exchange of data and take appropriate action as needed.

At block 319, the trained LLM service provider 139 can detect an exchange of data on the distributed ledger 103. In various examples, a transaction tracer 149 can be used by the trained LLM service provider 139 and/or the trained LLM 143 to detect the exchange of data via examination of the distributed ledger 103 and capturing data exchanged on it. Via the transaction tracer 149, the trained LLM service provider 139 can capture an execution of a transaction between the distributed agent 119 and the third-party LLM service provider computing environment 106.

At block 323, the trained LLM service provider 139 can evaluate the exchange of data captured by the transaction tracer 149 (e.g., the prompt event initiated by the distributed agent 119). In some examples, the trained LLM service provider 139 can calculate a similarity (or difference) between data captured from the exchange of data and preexisting data. In some examples, the data captured from the exchange of data can be transformed into normalized vector representations by the trained LLM 146 or other means and compared to normalized vector representations of preexisting data. For example, the trained LLM 146 can use a transformer encoder to transform, via application of a vocabulary embedding layer, the exchange of data into at least a normalized vector representation and make comparisons to normalized vector representations of preexisting data. Furthermore, a calculation for similarity can be performed between the normalized vector representation of the data captured from the exchange of data and preexisting vector representations (e.g., normalized vector representations of preexisting data that are stored in the trained LLM provider data store 143). The calculation may be based on a cosine similarity. Alternatively, the similarity may be based on Euclidean distance or dot product similarity or a similarity of another sort. The vector representation may be put through at least a test to determine at least a similarity with preexisting vector representations. The tests may include a hallucination test, a bias test, a copyright test, a code generator test, a harmful content test, an offensive language test, a sensitive data element test, a license violation test, or a combination thereof. The vector representations transformed from the data being exchanged does not have to be identical to preexisting vector representations but instead can be of a predetermined or particular level of similarity.

At block 326, the trained LLM service provider 139 can block the transaction, including the exchange of data, from at least reaching the third-party LLM service provider 129. For example, the trained LLM service provider 139 can block the transaction using a protection module 159 and/or other means upon a detection of at least an anomaly upon comparing the data to data related to the preexisting data. For example, the trained LLM service provider 139 may block the transaction causing the exchange of data upon determining that a predefined number of anomalies is similar between data associated with the exchange of data and data associated with the preexisting data. Alternatively, or in addition, the trained LLM service provider 139 may block the transaction causing the exchange of data upon a determination that the type of detected anomalies are of a predefined type.

At block 329, the trained LLM service provider 139 can record details, including transaction metadata, associated with the blocked transaction on the distributed ledger 103. In some examples, the trained LLM service provider 139 can write or otherwise store the detailed associated with the blocked transaction on the distributed ledger 103. For example, blocking of the transaction can invoke a write function associated with the third-party LLM service provider 129 to write the details associated with the blocked transaction, including details associated with at least an anomaly that was found, to the distributed ledger 103.

Next, at block 333, the trained LLM service provider 139 can report details associated with the blocked transaction to the client application 126 associated with the client device 113. In some examples, the trained LLM service provider 139 can transmit the details associated with the blocked transaction to the distributed agent 119 and/or client application 126 over the network 116, via an API call, and/or other means of communication. The client application 126 can render or otherwise display a notification or alert concerning the blocked transaction on a user interface 166 to allow a user to review the details associated with the blocked transaction. Thereafter, this portion of the process proceeds to completion.

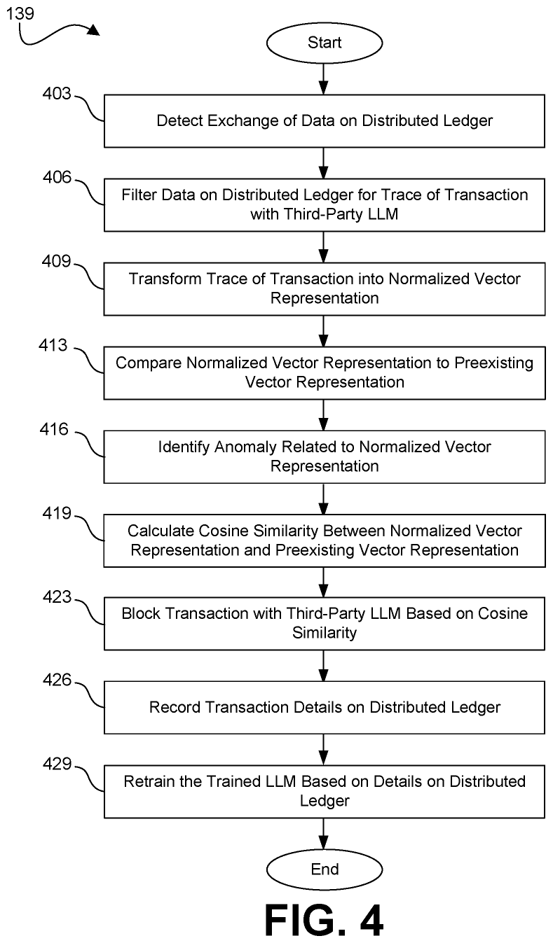

Referring next to FIG. 4, shown is a flowchart that provides one example of the operation of a portion of the trained LLM service provider 139. The flowchart of FIG. 4 provides merely an example of the many different types of functional arrangements that can be employed to implement the operation of the depicted portion of the trained LLM service provider 139. As an alternative, the flowchart of FIG. 4 can be viewed as depicting an example of elements of a method implemented within the network environment 100.

Beginning with block 403, the trained LLM service provider 139 can detect an exchange of data (e.g., a generated response being transmitted by the third-party LLM service provider 139, a prompt event initiated by the distributed agent 119, etc.) on the distributed ledger 103. The trained LLM service provider 139 can use a transaction tracer 149 to capture an execution of a transaction between the distributed agent 119 and the third-party LLM service provider computing environment 106. The transaction tracer 149 can analyze the distributed ledger 103 and capture an exchange of data between the distributed agent 119 and the third-party LLM 133. The data can include details associated with natural persons, entities, organizations, etc. The exchange of data may have been initiated by a distributed agent 119, an application (e.g., the client application 126), etc.

Next, at block 406, the trained LLM service provider 139 can use the service of the transaction tracer 149 to filter the data on the distributed ledger 103 for at least a trace of a transaction with a third-party LLM service provider 129. The transaction tracer 149 can analyze the trace of the transaction with a third-party LLM service provider 129 and capture an exchange of data between the distributed agent 119 and the third-party LLM 133. The captured data can include inputs and outputs associated with the distributed agent 119 and the third-party LLM 133. The captured data can include details related to the time taken for the third-party LLM to process each input and generate each output. The captured data can include resources from the third-party service provider computing environment 106 used by the third-party LLM 133. The captured data can include performance of the third-party LLM 133 over time. Furthermore, the trained LLM 146 is trained on data captured from an application of the transaction tracer 149 at least in part based on preexisting data. As a result, the trained LLM 146 can differentiate between normal transactions and anomalous transactions between the client device 113, the distributed agent 119, and the third-party LLM 133.

Next, at block 409, once the trained LLM service provider 139 verifies, using the transaction tracer 149 for example, that the exchange of data was with the third-party LLM, the trained LLM service provider 139 can utilize, for example, a transformer encoder to transform at least a trace of the transaction into at least a vector representation. In some examples, the transformer encoder can be used, by the trained LLM 146 or other means, to transform the trace of the transaction into at least a normalized vector representation.

Next, at block 413, the trained LLM service provider 139 can compare the vector representation to a preexisting vector representation of preexisting data to determine similarities and differences. In some examples, the trained LLM service provider 139 can use a detection module 156 to calculate a similarity (or difference) between the vector representation of the trace of the transaction and preexisting vector representations from preexisting data. The preexisting vector representations can be stored in, for example, the trained LLM provider data store 143.

Continuing to block 416, the trained LLM service provider 139 can identify at least an anomaly within the vector representation of the transformed data based on the comparison to the preexisting vector representation. There can be one or more anomalies identified. The comparison to preexisting vector representation may result in a discovery of an anomaly in one preexisting vector representation or multiple. The anomaly may be identified based on a combination of vector representations from the exchange of data. The anomaly may be identified by comparison to a single or multiple preexisting vector representations.

Next, at box 419, the trained LLM service provider 139 can calculate a similarity (or difference) between the vector representation and the preexisting vector representation. The calculation may be based on a cosine similarity. Alternatively, the similarity may be based on Euclidean distance or dot product similarity or a similarity of another sort. The vector representation may be put through at least a test to determine at least a similarity with preexisting vector representations.

The tests can include a hallucination test, a bias test, a copyright test, a code generator test, a harmful content test, an offensive language test, a sensitive data element test, a license violation test, or a combination thereof. The vector representations transformed from the data being exchanged does not have to be identical to preexisting vector representations. The hallucination test may include verifying that the data is accurate, real, and not nonsensical. The bias test may include determining whether the treats different demographics equally. The copyright test may include determining whether the material being shared is shareable and is not infringing on intellectual property protection as related to copyright law. The code generator test may include determining whether the data being shared can be used to generate new code, the code causing negative issues upon execution. The harmful content test may comprise evaluating whether the data being shared contains images, sounds, content of any sort which may be harmful to any person, entity, or organization. The offensive language test may comprise evaluating whether the data being shared contains images, sounds, or language presented in any form that may be offensive to any person, entity, or organization. The sensitive data element test may include testing to see whether any health records, business records, or records of any sort that are to be kept private are instead being shared in the data being exchanged. The license violation test may check to see whether there is any use, distribution or modification of a software product or its source code in a manner that is not in compliance with the terms and conditions specified by the software's license.

Continuing to block 423, the trained LLM service provider 139 can block the transaction including the exchange of data with the third-party LLM service provider computing environment 106 based on the determined similarity. The trained LLM service provider 139 can use a protection module 159 or other approaches to prevent further exposure of the transaction to the distributed ledger 103, the distributed agent 119, and/or the client application 126.

At block 426, the trained LLM service provider 139 can record details, including transaction metadata, associated with the blocked transaction on the distributed ledger 103. In some examples, the trained LLM service provider 139 can write or otherwise store the detailed associated with the blocked transaction on the distributed ledger 103. For example, blocking of the transaction can invoke a write function associated with the third-party LLM service provider 129 to write the details associated with the blocked transaction, including details associated with at least an anomaly that was found, to the distributed ledger 103.

Additionally, at block 429, the trained LLM service provider 139 can retrain the trained LLM 146 based on the details concerning the blocked transaction. In some implementations, the trained LLM 146 can initially be trained by being bootstrapped by another model or component. The trained LLM 146 can also be retrained on the details published on the distributed ledger 103 as the trained LLM 146 continues to learn through detection of anomalies and unsupervised learning. In some implementations, the trained LLM service provider 139 can also notify the client application 126 of the blocked transaction and the reasons why it was blocked.

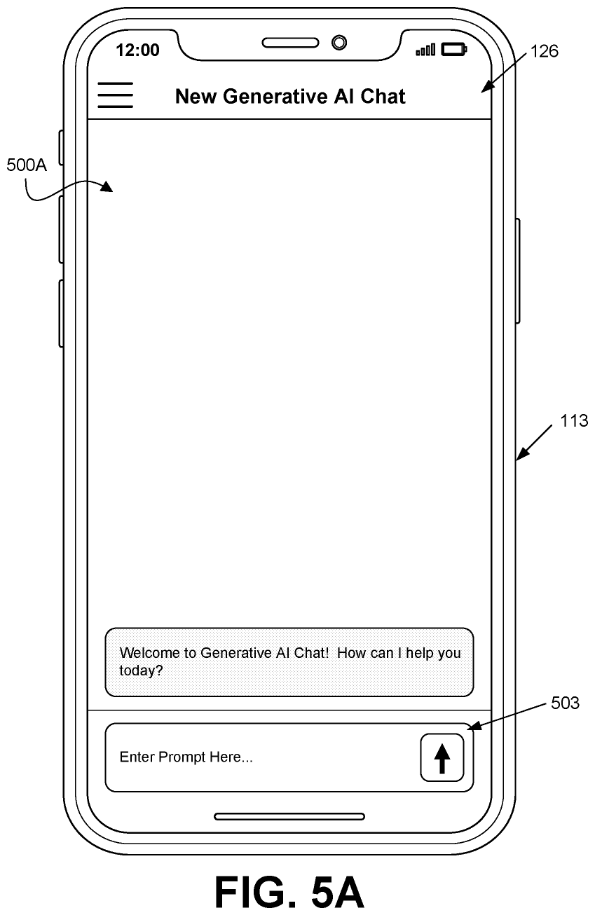

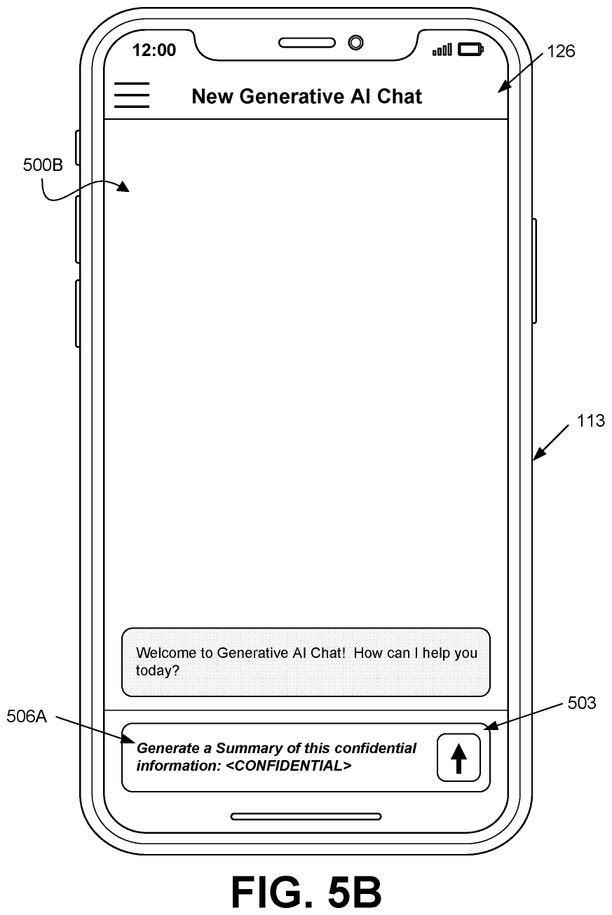

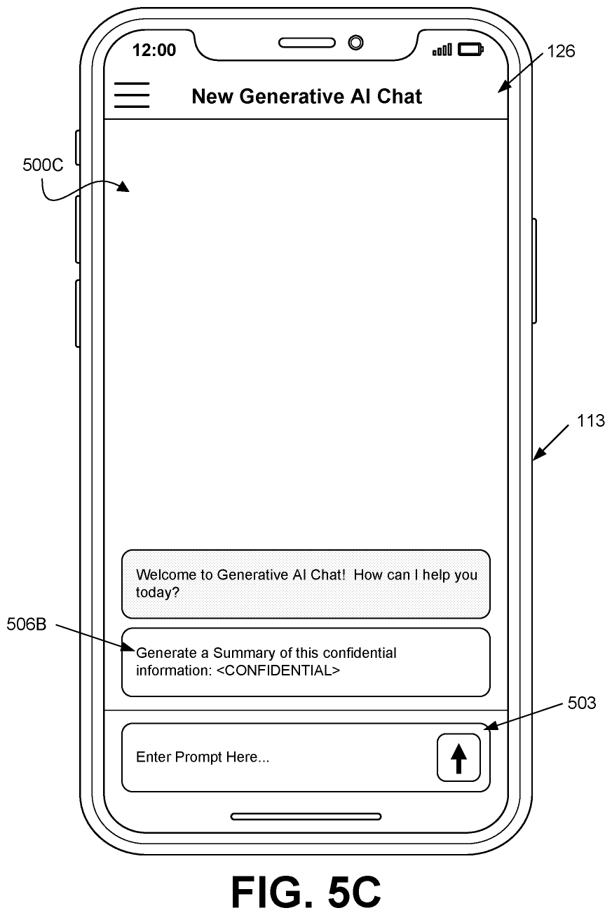

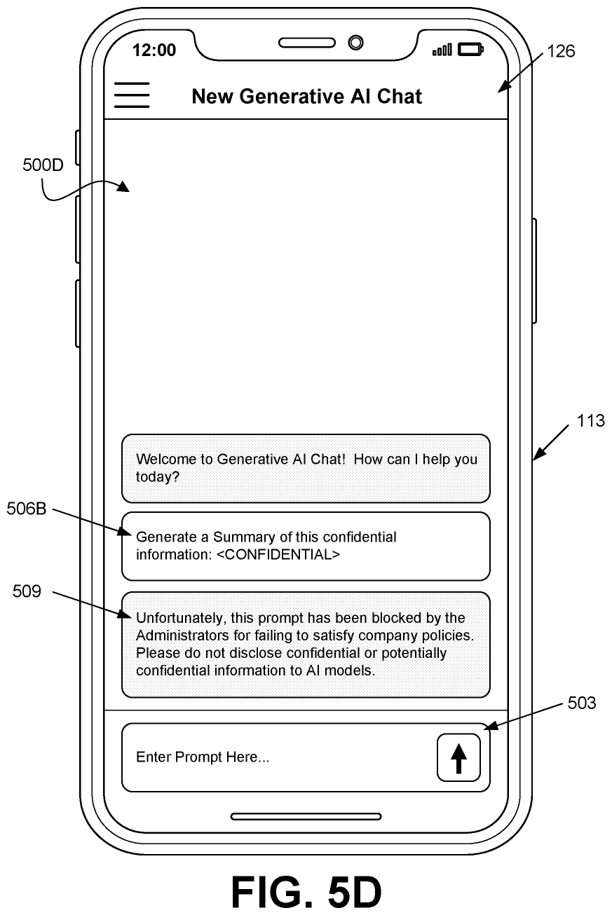

FIGS. 5A-5D illustrate examples of how a user might interact with a user interface 500A-500D of a client application 126 presented on a display 163 of a client device 113 to connect with a third-party LLM 139. However, a user could interact with the client device 113 in other manners to connect with the third-party LLM 139 in the same or other ways.

Beginning with FIG. 5A, shown is a pictorial diagram of an example user interface 500A rendered by the client device 113 in the network environment 100 of FIG. 1 according to various embodiments of the present disclosure. In various embodiments, the client application 126 can generate the user interface 500A for it to be rendered by the client device 113. The user interface 500A can be representative of a browser, an application page, or other interface to interact with a user. The user interface 500A can include various navigation affordances, such as forward button(s), backward button(s), refresh button(s), home button(s), a prompt input field 503, and various other elements to navigate in the client application 126. In various embodiments, the prompt input field 503 can receive various types of input from the user, such as text input, file input, number input, date input, or other types of input. If a prompt input field 503 is configured to receive file input, the prompt input field 503 can be configured to limit to specific file types, maximum file sizes, minimum file sizes, and/or other various configurations. As shown in FIG. 5A, the prompt input field 503 can be configured to receive text, such as a text prompt entered by a user. Various embodiments of the prompt input field 503 can include a submit button, which can direct the client application 126 to send a submitted prompt from the prompt input field 503 to be reviewed.

Referring next to FIG. 5B, shown is a pictorial diagram of an example user interface 500B rendered by the client device 113 in the network environment 100 of FIG. 1 according to various embodiments of the present disclosure. In the prompt input field 503 included in the user interface 500B, a user can type or otherwise enter a prompt 506A to send to the third-party LLM 139 via the client application 126. For example, the user can type or otherwise enter “Generate a Summary of this confidential information: <CONFIDENTIAL>” as a prompt 506A. Upon being entered, the prompt 506A can be displayed in the prompt input field 503, as shown in FIG. 5B. Although FIG. 5B depicts the term “<CONFIDENTIAL>” shown in the prompt, “<CONFIDENTIAL>” can represent a placeholder for information that would be otherwise confidential, secret, and/or protected. For instance, confidential, secret, and/or protected information can include confidential business information (e.g., trade secrets, business plans, client lists, lists of transactions, etc.), confidential personal information (e.g., names, addresses, social security numbers, phone numbers, e-mail addresses, etc.), government classified information, confidential communications (e.g., client communications, etc.), information protected by law (e.g., HIPAA protected patient information, payment card industry (PCI) compliance protected information, etc.).

Referring next to FIG. 5C, shown is a pictorial diagram of an example user interface 500C rendered by the client device 113 in the network environment 100 of FIG. 1 according to various embodiments of the present disclosure. Upon clicking the submit button of the prompt input field 503, the client application 126 can send, broadcast, or otherwise communicate the inputted information as a prompt and the prompt 506B can be rendered to the user interface 500C. For example, the user has selected to send the prompt “Generate a Summary of this confidential information: <CONFIDENTIAL>” has been sent to be processed by the third-party LLM 139 via the client application 126. As shown in FIG. 5C, the prompt “Generate a Summary of this confidential information: <CONFIDENTIAL>” is rendered as prompt 506B to the user interface 500C. Although FIG. 5C depicts the term “<CONFIDENTIAL>” shown in the prompt 506B, “<CONFIDENTIAL>” can represent a placeholder for information that would be otherwise confidential, secret, and/or protected, as previously described in the discussion of FIG. 5B.

Referring next to FIG. 5D, shown is a pictorial diagram of an example user interface 500D rendered by the client device 113 in the network environment 100 of FIG. 1 according to various embodiments of the present disclosure. After the prompt 506B has been sent, the client application 126 can receive a response message 509 concerning treatment of the prompt 506B. The response message 509 can be displayed on the user interface 500D. For example, after the user sends the prompt 506B, a response message 509 can be rendered to user interface 500D, where the response message 509 states that the prompt 506B is blocked and details that the prompt 506B was blocked because the prompt 506B disclosed confidential or potentially confidential information to AI models. As shown in FIG. 5D, the response message 509 can state “Unfortunately, this prompt has been blocked by the administrators for failing to satisfy company policies. Please do not disclose confidential or potentially confidential information to AI models.” In various embodiments, the response message received by the client application 126 can include an indication of the specific language that is deemed confidential. Various embodiments can highlight, emphasize, underline, or draw attention to the information that is deemed confidential from the prompt 506B so that the user can identify what information can be removed to successfully cause a prompt to succeed. Thereafter, this portion of the process can proceed to completion.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams and the flowchart show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams and the flowchart a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams and the flowchart can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
filter data generated by execution of a distributed agent, hosted on a distributed ledger, for at least a trace of a transaction associated with a third-party large language model;
use a trained large language model to analyze the at least one trace of the transaction;
identify at least one anomaly related to the at least one trace of the transaction; and
block the transaction based at least in part on the at least one anomaly.

2. The system of claim 1, wherein the machine-readable instructions further cause the computing device to at least record, on a distributed ledger, the details, including transaction metadata, associated with the blocking of the transaction.

3. The system of claim 1, wherein the trained large language model is trained at least in part on preexisting data to differentiate between normal transactions and anomalous transactions.

4. The system of claim 1, wherein the machine-readable instructions further cause the computing device to at least retrain the trained large language model based at least in part on details, including transaction metadata, associated with blocking of the transaction.

5. The system of claim 1, wherein the machine-readable instructions that cause the computing device to block the transaction further cause the computing device to block the transaction when a predefined number of anomalies is reached.

6. The system of claim 1, wherein the machine-readable instructions that cause the computing device to block the transaction further cause the computing device to block the transaction based at least in part on an anomaly reaching a certain ranking.

7. The system of claim 1, wherein the anomaly is identified at least in part due to a similarity the anomaly has with at least one preexisting anomaly.

8. The system of claim 1, wherein the trained large language model analyzes the at least one trace of the transaction by transforming the at least one trace of the transaction into at least one normalized vector representation.

9. A method, comprising:
filtering data from a distributed ledger for at least one trace of a transaction associated with a third-party large language model;
converting, using a trained large language model, the at least one trace of the transaction into at least one vector representation;
identifying at least in part one anomaly related to the at least one vector representation;
blocking the transaction based at least in part on a similarity between the at least one anomaly related to the at least one vector representation and a preexisting anomaly related to a stored vector representation; and
recording, on the distributed ledger, details, including transaction metadata, of the blocking of the transaction.

10. The method of claim 9, wherein the anomaly is identified at least in part due to the vector representation being normalized.

11. The method of claim 9, wherein blocking the transaction further comprises calculating a cosine similarity between the at least one anomaly and the preexisting anomaly.

12. The method of claim 9, wherein blocking the transaction further comprises analyzing performance of the at least one vector representation on at least one of: a hallucination test, a bias test, a copyright test, a code generator test, a harmful content test, an offensive language test, a sensitive data element test, a license violation test or a combination thereof.

13. The method of claim 9, further comprising retraining the trained large language model based at least in part on the recording of the details, including transaction metadata, of the blocking of the transaction.

14. The method of claim 9, further comprising using the at least one trace of the transaction as a breach notification in a system of a third-party associated with the exchange.

15. A non-transitory, computer-readable medium, comprising machine-readable instructions that, when executed by a processor of a computing device, cause the computing device to at least:
detect an exchange of data with a third-party large language model on a distributed ledger;
filter the data for at least one trace of a transaction associated with the third-party large language model;
transform the data into at least one normalized vector representation;
compare the at least one normalized vector representation to at least one preexisting vector representation from a database of vector representations;
identify at least one anomaly based on a comparison of the at least one normalized vector representation to the at least one preexisting vector representation; and
block the transaction based at least in part on the at least one anomaly.

16. The non-transitory, computer-readable medium of claim 15, wherein a large language model is used to transform the data.

17. The non-transitory, computer-readable medium of claim 16, wherein the large language model is trained based at least in part on details, including transaction metadata, associated with the exchange of data.

18. The non-transitory, computer-readable medium of claim 15, wherein the database of vector representations includes at least one preexisting vector representation based at least in part on a stored record of a preexisting anomaly.

19. The non-transitory, computer-readable medium of claim 15, wherein the database of vector representations includes at least one preexisting vector representation based at least in part on a stored record of a generated anomaly.

20. The non-transitory, computer-readable medium of claim 15, wherein the details, including transaction metadata, associated with the exchange of data are recorded in a private node of the distributed ledger, the private node being made accessible only to verified peers.
